(19) United States
(12) Patent Application Publication
(10) Pub. No.: US 2020/0209186 A1
(43) Pub. Date: Jul. 2, 2020

(54) GAS SENSING DEVICE AND GAS SENSING SYSTEM

(71) Applicant: INDUSTRIAL TECHNOLOGY RESEARCH INSTITUTE, Hsinchu (TW)

(72) Inventors: Chen Wei LIU, Taichung City (TW); Chun Chi CHEN, Taoyuan City (TW); Hsin-Hsien WU, Hsinchu City (TW); Hsin Yi HUANG, Taoyuan City (TW)

(73) Assignee: INDUSTRIAL TECHNOLOGY RESEARCH INSTITUTE, Hsinchu (TW)

(21) Appl. No.: 16/727,675

(22) Filed: Dec. 26, 2019

(30) Foreign Application Priority Data
Dec. 28, 2018 (TW) 107147788
Sep. 17, 2019 (TW) 108133461

(51) Int. Cl. G01N 27/413

(52) U.S. Cl. CPC G01N 27/413

(57) ABSTRACT

A gas sensing device comprises a housing, a cover, and a gas sensing module. The housing has an accommodating space. The cover is disposed on the housing. The cover has a top surface, a bottom surface, and a gas passage. The bottom surface faces the accommodating space. The gas passage is communicated with the accommodating space. The gas passage has a first opening and a second opening. The first opening is located on the top surface. The second opening is located on the bottom surface. The area of the first opening is larger than the area of the second opening. A gas sensing system comprises two aforementioned gas sensing devices, and one of the gas sensing devices is provided with a filter module.

### CROSS-REFERENCE TO RELATED APPLICATIONS

This non-provisional application claims priority under 35 U.S.C. § 119(a) on Patent Application No(s). 107147788 filed in Taiwan, R.O.C. on Dec. 28, 2018, and Patent Application No(s). 108133461 filed in Taiwan, R.O.C. on Sep. 17, 2019 the entire contents of which are hereby incorporated by reference.

### BACKGROUND

### 1. Technical Field

This disclosure relates to a gas sensing device and a gas sensing system, and more particularly to a gas sensing device and a gas sensing system with an ability to enhance the diffusion of airflow.

### 2. Related Art

In our environment, hazardous conditions, such as an explosion, fire or toxicity, may occur, therefore a gas sensing device is required for detection of the concentrations of potentially dangerous gasses. The gas sensing device must respond to a specific gas which we are trying to detect (target gas), such as CO, nitrogen oxides, SO₂, H₂S, CO₂, H₂, PH₃, O₃ and the like, with a reliable sensitivity.

### SUMMARY

The gas sensing device according to the present disclosure includes a housing, a cover, and a gas sensing module. The housing has an accommodating space. The cover is disposed on the housing. The cover has a top surface, a bottom surface, and a gas passage. The bottom surface faces the accommodating space. The gas passage is communicated with the accommodating space. The gas passage has a first opening and a second opening. The first opening is located on the top surface. The second opening is located on the bottom surface. The area of the first opening is larger than the area of the second opening. The gas sensing module is disposed in the accommodating space.

The gas sensing system according to the present disclosure includes a carrier, a first gas sensing device, and a second gas sensing device. The first gas sensing device is disposed on the carrier. The first gas sensing device has a structure of the aforementioned gas sensing device. The second gas sensing device is disposed on the carrier. The second gas sensing device has a structure of the aforementioned gas sensing device. The second gas sensing device further includes a filter module. The filter module includes a fixed structure and a selective filter material. The fixed structure is disposed on the cover and located in the accommodating space. The selective filter material is disposed in the fixed structure, and the selective filter material covers the second opening.

The above description and the following embodiments are used to demonstrate and explain the spirit and principle of the present disclosure, and provide a further explanation of the claims.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1A is a cross-section view of the gas sensing device according to the first embodiment of the present disclosure.

FIG. 1B is an enlarged portion of the gas sensing device according to the first embodiment of the present disclosure.

FIG. 2 is a stereogram of the gas sensing device according to the first embodiment of the present disclosure.

FIG. 3 is a cross-section view of the gas sensing device according to the second embodiment of the present disclosure.

FIG. 4 is an exploded view of the gas sensing device according to the second embodiment of the present disclosure.

FIG. 5 is a stereogram view of the gas sensing device according to the second embodiment of the present disclosure.

FIG. 6 is a schematic view of the cover of the gas sensing device according to the second embodiment of the present disclosure.

FIG. 7 is a schematic view of the filter module of the gas sensing device according to the second embodiment of the present disclosure.

FIG. 8 is a cross-section view of the gas sensing module of the gas sensing device according to the second embodiment of the present disclosure.

FIG. 9 is an exploded view of the gas sensing module of the gas sensing device according to the second embodiment of the present disclosure.

FIG. 10 is a schematic view of the upper part of the inner container of the gas sensing device according to the second embodiment of the present disclosure.

FIG. 11 is a schematic view of the lower part of the inner container of the gas sensing device according to the second embodiment of the present disclosure.

FIG. 12 is a schematic view of the housing of the gas sensing device according to the second embodiment of the present disclosure.

FIGS. 13A and 13B are flow field diagrams of the first embodiment and/or the second embodiment and the comparative example according to the present disclosure.

FIG. 14 is a SEM image of the selective filter material including the combination of metal oxide and hydrophobic polymer.

FIG. 15 is a schematic view of the gas sensing system according to the third embodiment of the present disclosure.

FIG. 16 is a diagram for gas concentration detected by the gas sensing device including a filter module according to the present disclosure.

FIG. 17 is a curve diagram for the current depending on the time of the gas sensing system according to the third embodiment of the present disclosure.

FIG. 18 is a diagram for the concentration of NO₂ detected by the gas sensing system according to the third embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings. In the following and drawings, the similar members are represented by the same reference numbers.

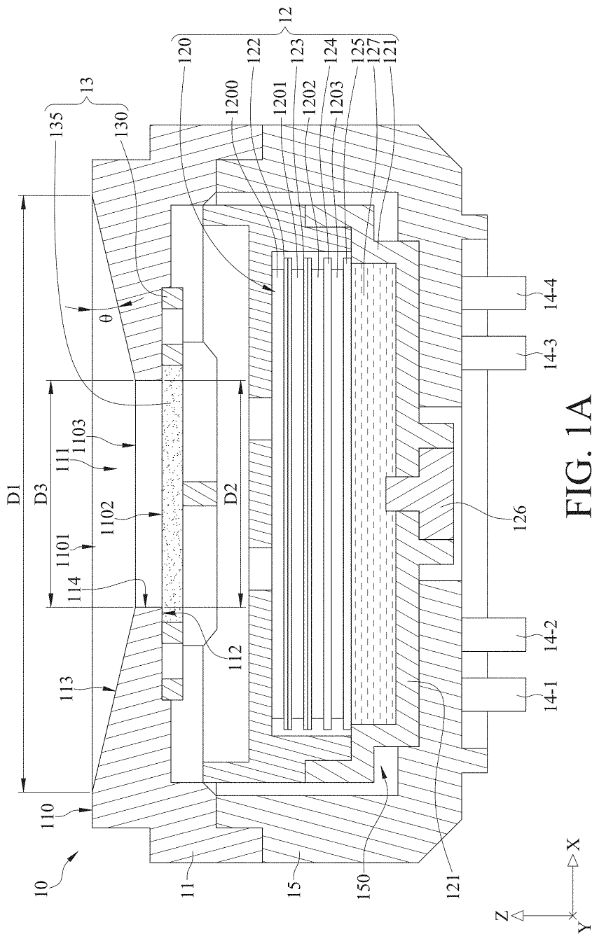

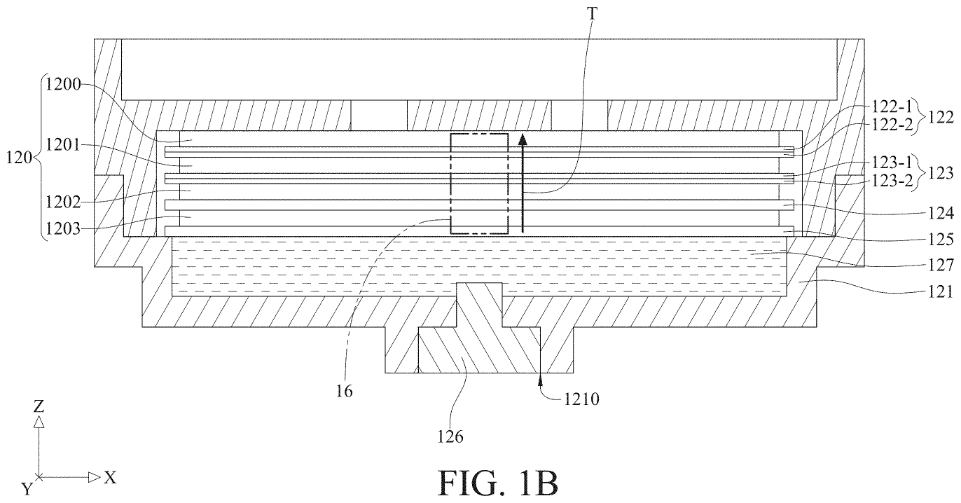

Please refer to FIG. 1A, FIG. 1B and FIG. 2, FIG. 1A is a cross-section view of the gas sensing device according to the first embodiment of the present disclosure. FIG. 1B is an enlarged portion of the gas sensing device according to the first embodiment of the present disclosure. FIG. 2 is a stereogram of the gas sensing device according to the first embodiment of the present disclosure. As shown in FIG. 1A, the gas sensing device 10 in the first embodiment of the present disclosure includes a housing 15, a cover 11 and a gas sensing module 12. The housing 15 has an accommodating space 150. The cover 11 is disposed on the housing 15.

In the first embodiment according to the present disclosure, the housing 15 is cylindrical. In other embodiments, the housing 15 may be rectangular or polygonal column shaped. The structure sizes of the housing 15 and the cover 11 are exemplary, for example, in FIG. 1A, the housing 15 is in the shape of a cylinder with a larger width, but the present disclosure is not limited thereto.

In the first embodiment according to the present disclosure, the cover 11 includes a top surface 110, a bottom surface 112, and a gas passage 111. The bottom surface 112 faces the accommodating space 150, and the gas passage 111 is communicated with the accommodating space 150. The gas passage 111 has a first opening 1101 and a second opening 1102, the first opening 1101 is located on the top surface 110, and the second opening 1102 is located on the bottom surface 112. In detail, the gas passage 111 further includes a sloped surface 113, a wall surface 114, and a third opening 1103. One side of the sloped surface 113 is connected to the top surface 110, and the opposite side of the sloped surface 113 is connected to one side of the wall surface 114. The third opening 1103 is located on the boundary of the sloped surface 113 and the wall surface 114. One side of the wall surface 114, away from the sloped surface 113, is connected to the bottom surface 112. The second opening 1102 is located on center of the bottom surface 112 and communicated with the accommodating space 150. In other words, the bottom surface 112 is parallel to the horizontal plane and extends from the center of the second opening 1102, but the present disclosure is not limited thereto. In other embodiments according to the present disclosure, the second opening 1102 may be not located at the center of the bottom surface 112, and the bottom surface 112 may be not parallel to the horizontal plane. The diameter D2 of the second opening 1102 may be equal to, or smaller than the diameter D3 of the third opening 1103 (D2≤D3). In FIG. 1A, the diameter D2 is equal to the diameter D3. In other embodiments, when the diameter D2 is smaller than diameter D3, the wall surface 114 is a sloped surface.

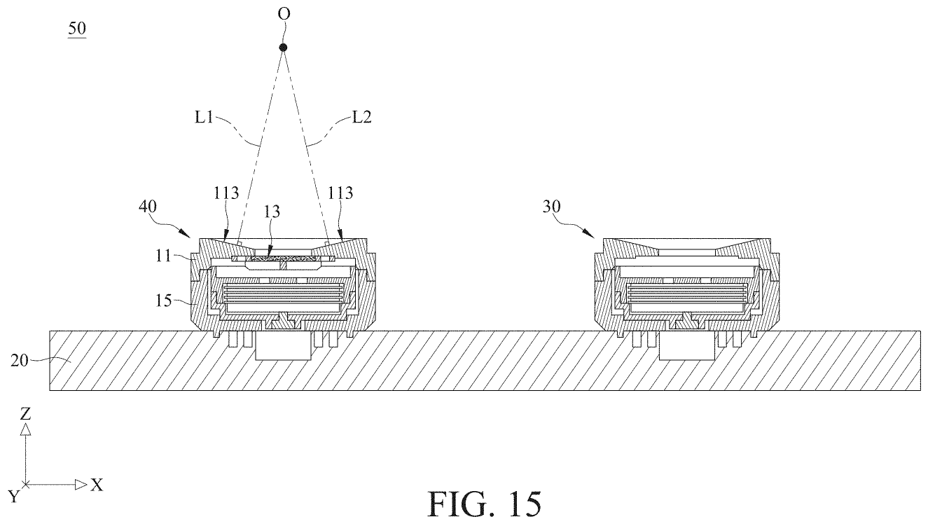

Please refer to FIG. 2, as shown in FIG. 2, the cover 11 has the top surface 110, the first opening 1101, and the second opening 1102. The area of the first opening 1101 is larger than the area of the second opening 1102 (horizontal cross-sectional area). The diameter D2 of the second opening 1102 is smaller than the diameter D1 of the first opening 1101 (D2<D1). Moreover, the center of the second opening 1102 overlaps the center of the first opening 1101 in the orthogonal projection of the first opening 1101, therefore the cover 11 has an inverted-cone or V-shaped slope structure. The angle θ between the sloped surface 113 and the horizontal plane is 14 degrees. In other embodiments, the angle between the sloped surface 113 and the horizontal plane may be from 14 to 42 degrees. That is, the intersection O of any two normal lines L1 and L2 on the sloped surface 113 is located on the z-direction of the housing 15, and the intersection O is located outside the housing 15 (shown in FIG. 15). Please refer to FIG. 1A, the partial flow field around the cover 11 can be adjusted because the cover 11 with the structure in which the diameter D2 of the second opening 1102 is smaller than the diameter D1 of the first opening 1101, so that the amount of gas entering the gas sensing device 10 through the first opening 1101 and the second opening 1102 can increase.

In the first embodiment, the shapes of the top surface 110, the first opening 1101, the second opening 1102, and the third opening 1103 are circles. In other embodiments, the shapes of the top surface 110, the first opening 1101, the second open 1102, and the third opening 1103 may be polygon or other geometric shapes, such as an ellipse, a trapezoid, a square, or a rectangle.

Please refer to FIG. 1A and FIG. 1B, in the first embodiment according to the present disclosure, the gas sensing module 12 includes a working electrode 1200, a first auxiliary electrode 1201, a reference electrode 1202, a second auxiliary electrode 1203, a first spacer 122, a second spacer 123, a third electrolyte hygroscopic membrane 124, a fourth electrolyte hygroscopic membrane 125, an electrolyte 127, and an electrolyte bath 121. A combination of the working electrode 1200, the first auxiliary electrode 1201, the reference electrode 1202 and the second auxiliary electrode 1203 is referred to as the electrochemical sensing electrode 120. The working electrode 1200 is disposed between the second opening 1102 and the first auxiliary electrode 1201. The first spacer 122 is located between the working electrode 1200 and the first auxiliary electrode 1201, and the first spacer 122 is electrically connected to the working electrode 1200 and the first auxiliary electrode 1201 (electrical connection is achieved by the electrolyte 127 in the first electrolyte hygroscopic membrane 122-1, and the electrolyte 127 generates free ions which are conductive in aqueous solution). The first spacer 122 includes a first electrolyte hygroscopic membrane 122-1 and a first waterproofing membrane 122-2. The second spacer 123 is located between the first auxiliary electrode 1201 and the reference electrode 1202, and the second spacer 123 is electrically connected to the first auxiliary electrode 1201 and the reference electrode 1202. The second spacer 123 includes a second electrolyte hygroscopic membrane 123-1 and a second waterproofing membrane 123-2. The third electrolyte hygroscopic membrane 124 is located between the second auxiliary electrode 1203 and the reference electrode 1202. The third electrolyte hygroscopic membrane 124 is used for electrical connection between the second auxiliary electrode 1203 and the reference electrode 1202. The fourth electrolyte hygroscopic membrane 125 is disposed between the second auxiliary electrode 1203 and the electrolyte bath 121. The electrolyte 127 is placed in the electrolyte bath 121, and an hygroscopic membrane (not shown) is located in the electrolyte bath 121. The hygroscopic membrane exposed from the top surface of electrolyte bath 121 is connected to the second auxiliary electrode 1203. Overall, the electrochemical sensing electrode 120 is located above the electrolyte bath 121, and the electrochemical sensing electrode 120 and the electrolyte 127 are physically and electrochemically connected to each other. In other embodiments, the first auxiliary electrode 1201 and the second spacer 123 may be not necessary. The working electrode 1200 and the first auxiliary electrode 1201 mentioned above provide respective current and voltage, and the values of current and voltage are calculated by a microprocessor to obtain the concentration of the target gas.

As shown in FIG. 1A, in the first embodiment according to the present disclosure, the working electrode 1200 includes metal material and porous material. The metal material may be ternary metal or monatomic metal. The ternary metal or monatomic metal is carried on the porous material, which means the porous material act as a carrier. In other embodiments, the porous material is carried on the hydrophobic polymer sheet. In one embodiment, the porous material has a zero-dimensional structure (particles or atoms) or a two-dimensional structure. The porous material may be a porous material made of carbon, such as a micro-sized carbon carrier, graphene, doped graphene (doping with elements such as N, P, B and the like), multi-walled carbon nanotube, single-walled carbon nanotube, and the like. In one embodiment, the structure of the ternary metal is a nanowire structure, and the ternary metal nanowire is a core-shell structure. One of the metals is the core, and the others cover the core sequentially. The ternary metal nanowire is spread on the porous material. The ternary metal consists of any three metals selected from a group consisting of Pt, Pd, Co, Ag, Sn, Cu, Ni, Au, and Ru, such as PtCoAg, PtSnAg, PtPdNi and the like. In one embodiment, one or more monatomic metal is spread on the porous material. The monatomic metal is any one metal selected from Pt, Pd, Co, Ag, Sn, Cu, Ni, Au, and Ru. In one embodiment, the working electrode 1200 includes a porous material and a plurality of metal particles made of single kind of metal material carried on the porous material. The diameter of the metal particles is about 1 Å or about the diameter of a monatomic metal particle. The metal particles include monatomic metal particles spread or scattered on the porous material, and the monatomic metal particles may be made of the same metal element. The metal element may be any one metal selected from Pt, Pd, Co, Ag, Sn, Cu, Ni, Au, and Ru. In another embodiment, the metal particles include several kinds of monatomic metal particles, which means the metal particles may be respectively made of different metals, that is, at least two kinds of monatomic metal particles are spread or scattered on the porous material. The metal elements may be any two metals selected from Pt, Pd, Co, Ag, Sn, Cu, Ni, Au, and Ru, for example, Au atom and Ag atom, Au atom and Co atom, Pt atom and Ni atom, Cu atom and Co atom, and Au atom and Cu atom.

Because there is a larger surface area on the nanoscale nanowire or monatomic structure, the redox reaction rate is faster. Therefore, the sensitivity and the accuracy of the gas sensing device 10 are improved through the working electrode 1200 containing the ternary metal nanowire or monatomic metal particles, so that a low concentration detection limit (ppb level) can be achieved.

In the first embodiment according to the present disclosure, the material of the first auxiliary electrode 1201 is the same as that of the working electrode 1200. The second auxiliary electrode 1203 includes a conductive material such as porous carbon material, Pt and the like. The reference electrode 1202 includes a conductive material such as AgCl, HgCl₂, Pt/C and the like. In other embodiments, the first auxiliary electrode 1201, the reference electrode 1202 and the second auxiliary electrode 1203 may be carried on different hydrophobic polymer sheets, respectively.

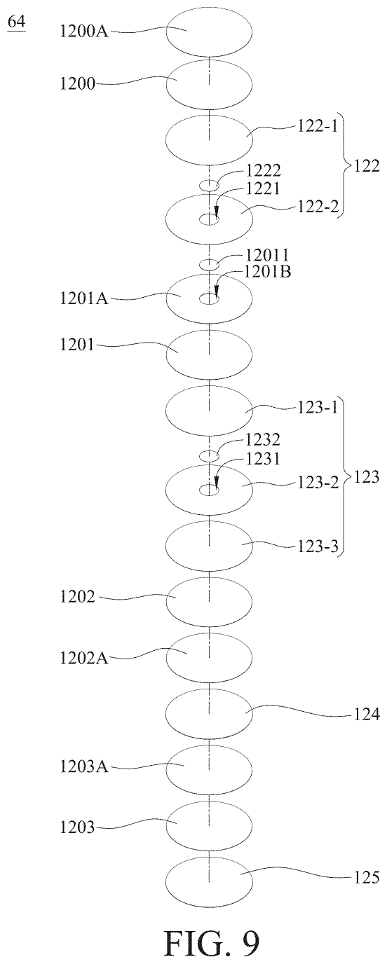

As shown in FIG. 1B, in the first embodiment according to the present disclosure, the first spacer 122 includes a first electrolyte hygroscopic membrane 122-1 and a first waterproofing membrane 122-2. The first electrolyte hygroscopic membrane 122-1 is disposed between the working electrode 1200 and the waterproofing membrane 122-2. The second spacer 123 includes a second electrolyte hygroscopic membrane 123-1 and a second waterproofing membrane 123-2. The second electrolyte hygroscopic membrane 123-1 is disposed between the first auxiliary electrode 1201 and the second waterproofing membrane 123-2. In other embodiments, the second waterproofing membrane 123-2 may be disposed between the two second electrolyte hygroscopic membranes 123-1. The first waterproofing membrane 122-2 and the second waterproofing membrane 123-2 are made of a stable impermeable polymer. The first electrolyte hygroscopic membrane 122-1 to the fourth electrolyte hygroscopic membrane 125 are used for ensuring the contact and infiltration of the electrolyte with the working electrode 1200, the first auxiliary electrode 1201, the reference electrode 1202, and the second auxiliary electrode 1203. The first electrolyte hygroscopic membrane 122-1, the second electrolyte hygroscopic membrane 123-1, the third electrolyte hygroscopic membrane 124, and the fourth electrolyte hygroscopic membrane 125 may be made of hydrophilic nonconductive material which the electrolyte 127 can pass through. The structure of each electrolyte hygroscopic membrane includes a porous structure or fabric structure for transporting the electrolyte 127 through the capillary effect (Please refer to FIG. 9, the detail description will be further described in the following). Each electrolyte hygroscopic membrane absorbs the electrolyte 127 from the electrolyte bath 121 to maintain the moist state of the electrolyte hygroscopic membranes containing electrolytes.

As shown in FIG. 1A and FIG. 1B, in the first embodiment according to the present disclosure, the electrolyte bath 121 has an opening 1210 at the central bottom of the electrolyte bath 121, and a plunger 126 is matched with and inserted in the opening 1210 to seal the electrolyte bath 121 after filling the electrolyte 127 into the electrolyte bath 121. The electrolyte 127 in the electrolyte bath 121 flows in the passage 16 extending from the lower side to the upper side along the direction T to pass sequentially through the fourth electrolyte hygroscopic membrane 125, the second auxiliary electrode 1203, the third electrolyte hygroscopic membrane 124, the reference electrode 1202, the second spacer 123, the first auxiliary electrode 1201, the first spacer 122, and the working electrode 1200. The passage 16 has a hygroscopic membrane as a wick for transporting the electrolyte 127 through the capillary effect. The electrolyte bath 121 is located on the bottom of the housing 15. The electrolyte 127 provided from the electrolyte bath 121 may include liquid electrolytes such as sulfuric acid, perchloric acid, ionic liquid and the like.

As shown in FIG. 1A, in the first embodiment according to the present disclosure, the filter module 13 includes a fixed structure 130 and a selective filter material 135. The fixed structure 130 is disposed on the cover 11 and located in the accommodating space 150. The selective filter material 135 is disposed in the fixed structure 130, and the selective filter material 135 covers the second opening 1102. The selective filter material 135 includes two sheets and metal oxides. The two sheets have a large number of holes which gas can pass through. The sheet is a hydrophobic porous polymer film, such as PTFE, PVDF and the like. As shown in FIG. 2, the metal oxide is disposed between the two sheets (for example, sandwiched between two sheets) to cover the second opening 1102.

The selective filter material 135 includes a metal oxide and a hydrophobic polymer as an adhesive. The metal oxide includes a one-dimensional nanostructure with β or γ crystalline phase. The metal oxide includes MnO₂, Mn₂O₃, Mn₃O₄ or MnOOH. For example, the metal oxide includes β-MnO₂ nanowire, γ-MnOOH nanowire. The selective filter material 135 containing the aforementioned MnO₂, Mn₂O₃, Mn₃O₄ or MnOOH can be used for removing O₃ in the detected gas. Because there is a larger surface area on the nanoscale metal oxide, a better removal efficiency can be achieved when removing the interfering gas from the detected gas by the metal oxide.

The particle size of the hydrophobic polymer may be 40 μm to 70 μm. The hydrophobic polymer is made of PFA, PTFE or PVDF.

In the first embodiment according to the present disclosure, the selective filter material 135 including a hydrophobic polymer and metal oxide has holes. When the detected gas is passing through the selective filter material 135, interfering gas can be absorbed by the selective filter material 135, and other gas can pass through the holes of the selective filter material 135 to enter the accommodating space 150. As shown in FIG. 1A, in the first embodiment according to the present disclosure, the gas sensing device 10 may include the filter module 13 used for removing the interfering gas, but the present disclosure is not limited thereto. In other embodiments, if removing the interfering gas is not necessary, the gas sensing device 10 may not include the filter module 13 for removing the interfering gas.

In the first embodiment according to the present disclosure, the gas sensing device 10 further includes a plurality of conductive structures 14-1 to 14-4. One end of each conductive structure 14-1 to 14-4 is disposed outside the housing 15, and the conductive structure 14-1 to 14-4 can be configured as a pin. The other end of each conductive structure 14-1 to 14-4 is electrically connected to the working electrode 1200, the first auxiliary electrode 1201, the reference electrode 1202 and the second auxiliary electrode 1203, respectively. The following connection is achieved by wire: the connection of the working electrode 1200 to the conductive structure 14-1; the connection of the first auxiliary electrode 1201 to the conductive structure 14-2; the connection of the reference electrode 1202 to the conductive structure 14-3; and the connection of the second auxiliary electrode 1203 to the conductive structure 14-4. The electrochemical sensing electrode 120 of the gas sensing device 10 utilizes four conductive structures 14-1 to 14-4 to acquire electric power from the outside for sensing the concentration of target gas and transferring the current generated by an electrochemical reaction. The current is transferred to the microprocessor (not shown) to calculate the concentration of the target gas. The calculated gas concentration can be provided for the user by an external display device (not shown).

Because the oxidation potential of NO₂ and O₃ are similar to each other, NO₂ and O₃ may interfere with each other so as to affect the accuracy of measurement when the gas sensing device 10 detects NO₂. Therefore, as shown in FIG. 1A, in the first embodiment according to the present disclosure, to distinguish between NO₂ and O₃, the gas removed by the filter module 13 is O₃ (regarding as interfering gas), and the accuracy of the gas sensing system for NO₂ can be improved through removing O₃. The gas sensing device 10 mentioned above includes an exemplary configuration when the detected gas contains O₃. In other embodiments, the corresponding metal oxide and electrolyte can be chosen when designing the gas sensing device 10 for specific interfering gas, such as CO, CO₂, nitrogen oxides, sulfur oxides, nitrogen hydrides, ammonia hydrides, phosphorus hydrides, sulfur hydrides, arsenic hydrides, boron hydrides, unsaturated or saturated hydrocarbon vapor of alcohol, aldehyde and hydrogen or halogenated hydrocarbons.

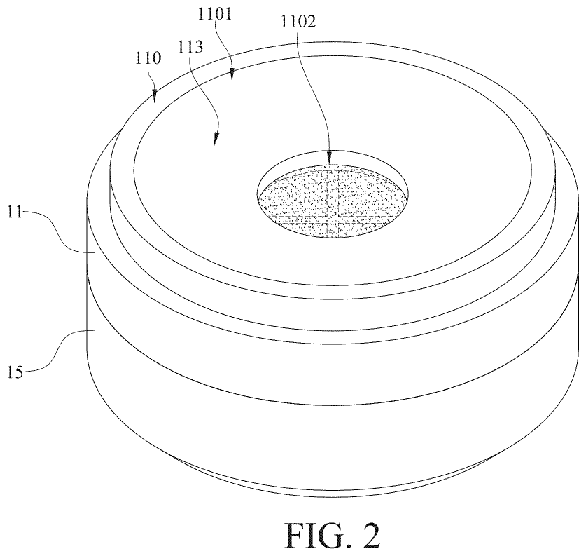

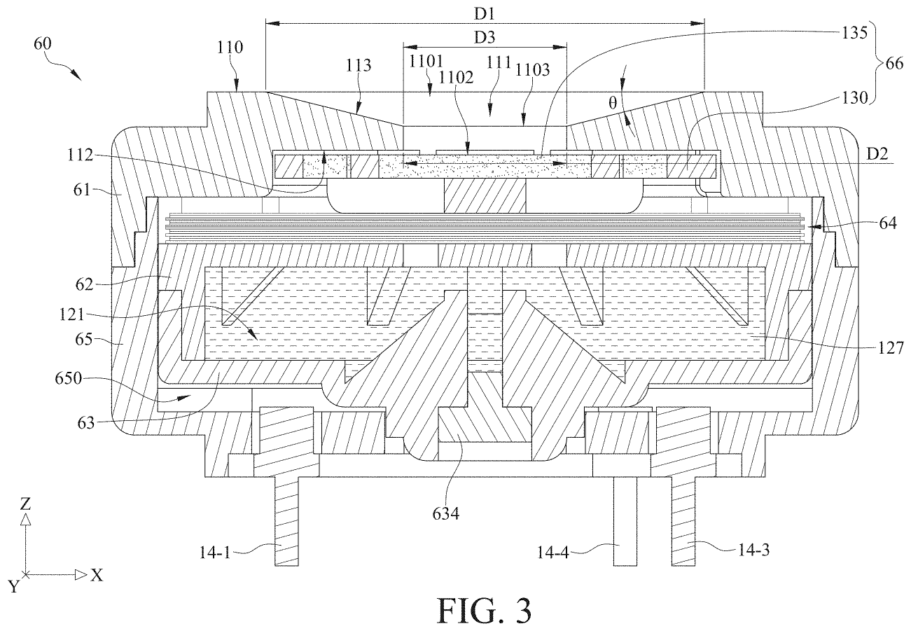

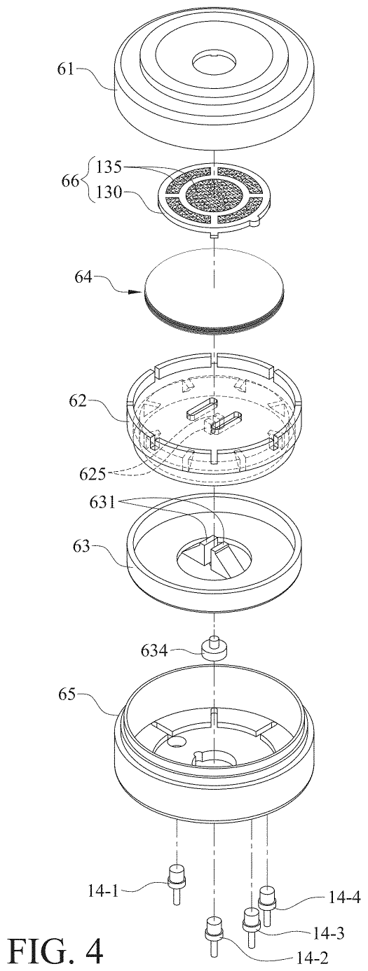

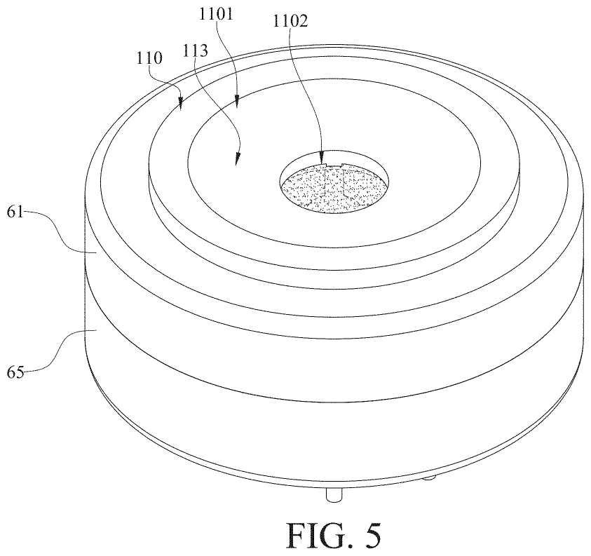

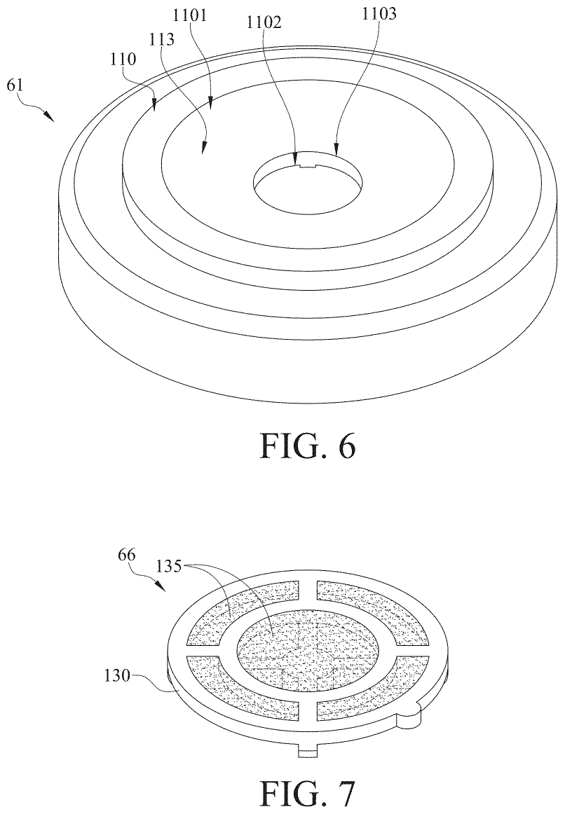

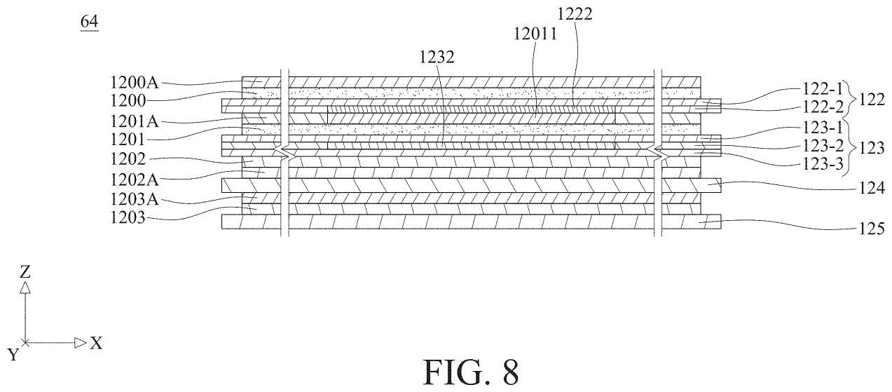

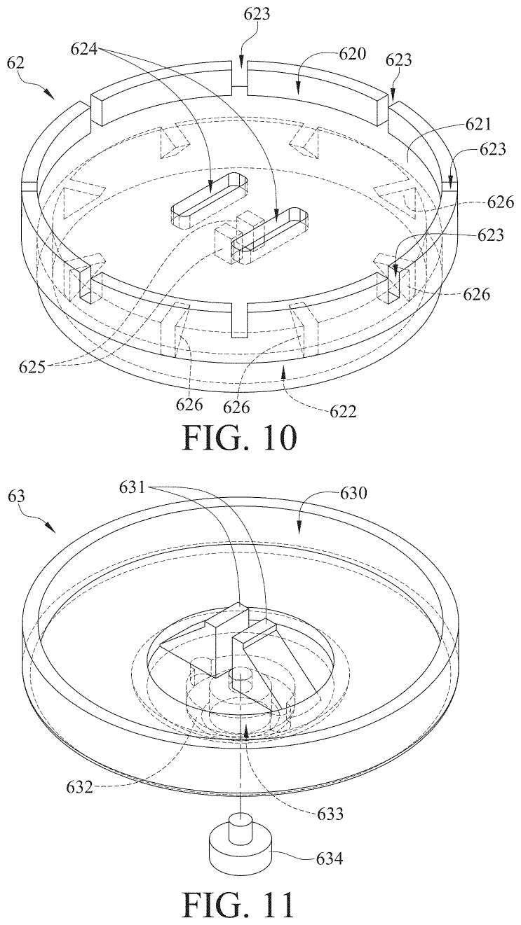

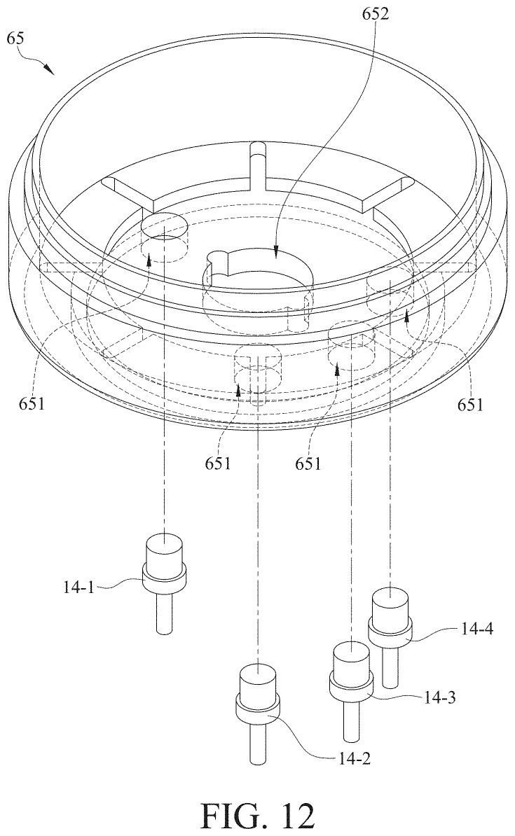

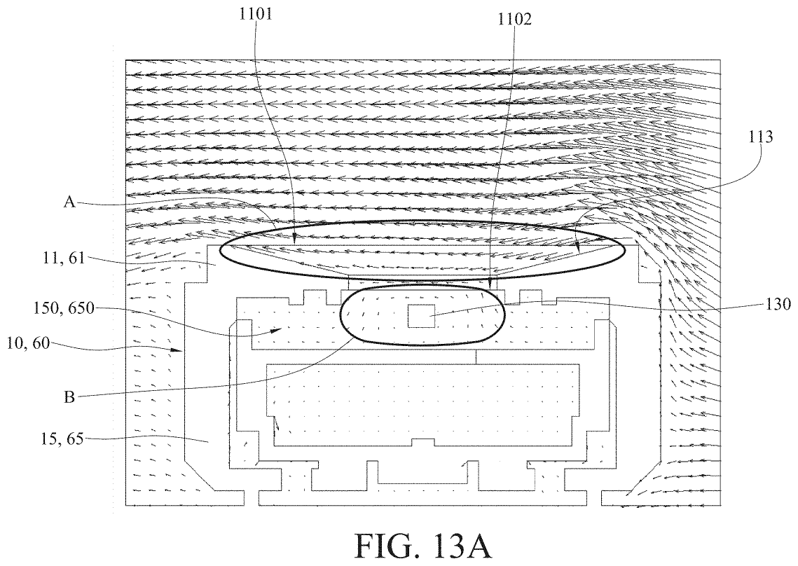

Please refer to FIG. 3 to FIG. 12. FIG. 3 is a cross-section view of the gas sensing device according to the second embodiment of the present disclosure. FIG. 4 is an exploded view of the gas sensing device according to the second embodiment of the present disclosure. FIG. 5 is a stereogram view of the gas sensing device according to the second embodiment of the present disclosure. FIG. 6 is a schematic view of the cover of the gas sensing device according to the second embodiment of the present disclosure. FIG. 7 is a schematic view of the filter module of the gas sensing device according to the second embodiment of the present disclosure. FIG. 8 is a cross-section view of the gas sensing module of the gas sensing device according to the second embodiment of the present disclosure. FIG. 9 is an exploded view of the gas sensing module of the gas sensing device 64 according to the second embodiment of the present disclosure. FIG. 10 is a schematic view of the upper part of the inner container of the gas sensing device according to the second embodiment of the present disclosure. FIG. 11 is a schematic view of the lower part of the inner container of the gas sensing device according to the second embodiment of the present disclosure. FIG. 12 is a schematic view of the housing of the gas sensing device according to the second embodiment of the present disclosure.

As shown in FIG. 3 to FIG. 5, the gas sensing device 60 in the second embodiment of the present disclosure includes a cover 61, an upper part 62 of the inner container, a lower part 63 of the inner container, a gas sensing module 64, a housing 65, and a filter module 66. The gas sensing module 64 and the filter module 66 are disposed between the cover 61 and the upper part 62 of the inner container. The upper part 62 of the inner container is disposed above the lower part 63 of the inner container. The lower part 63 of the inner container is disposed between the upper part 62 of the inner container and the housing 65. In another embodiment, the gas sensing device 60 may not include the filter module 66. FIG. 4 is an exploded view of the gas sensing device 60 according to the second embodiment of the present disclosure. The cover 61 and the housing 65 are assembled with each other as an outermost housing. The upper part 62 of the inner container and the lower part 63 of the inner container are fixed with each other through the first fixed member 625 and the second fixed member 631 so as to form an electrolyte bath 121 therein. A seal member 634 prevent the electrolyte leaking out from the electrolyte bath 121. The gas sensing module 64 is located between the upper part 62 of the inner container and the filter module 66. The filter module 66 is fixed on the bottom surface 112 of the cover 61. Especially, the gas sensing module 64 and the electrolyte bath 121 are separated by the upper part 62 of the inner container and communicated with each other only by a connection opening 624. FIG. 5 is a stereogram view of the gas sensing device 60 according to the second embodiment of the present disclosure. The cover 61 and the housing 65 are combined with each other as an outermost housing. Through the cover 61 with a structure in which the diameter D2 of the second opening 1102 is smaller than the diameter D1 of the first opening 1101 and the sloped surface 113, the amount of gas entering the gas sensing device 60 can be increased. The filter module 66 covers the second opening 1102 to filter the air and absorb specific gas.

As shown in FIG. 3, in the second embodiment according to the present disclosure, the housing 65 and the cover 61 has an accommodating space 650 therebetween. The upper part 62 of the inner container, the lower part 63 of the inner container, the gas sensing module 64, and a filter module 66 are located in the accommodating space 650. The configuration of the cover 61, the housing 65, and the filter module 66 in the second embodiment are similar to the configuration of the cover 11, the housing 15, and the filter module 13 in the first embodiment so that their structure and function are not described again here. FIG. 6 is a schematic view of the cover 61 of the gas sensing device according to the second embodiment of the present disclosure. The diameter D2 of the second opening 1102 is smaller than the diameter D1 of the first opening 1101 (D2<D1).

As shown in FIG. 7, in the second embodiment according to the present disclosure, the fixed structure 130 of the filter module 66 has holes for air flowing, and the selective filter material 135 is hold in these holes. The fixed structure 130 is disposed between the cover 61 and the gas sensing module 64. The filter module 66 in the second embodiment is similar to the filter module 13 in the first embodiment, and its structure and function are not described again here.

As shown in FIG. 8 and FIG. 9, in the cross-section view of the gas sensing module 64 and the exploded view of the gas sensing module 64 of the gas sensing device according to the second embodiment of the present disclosure, it only shows the stacking sequence of the layers. The size of each layer is only exemplary, and the present disclosure is not limited thereto. The gas sensing module 64 in the second embodiment is similar to the gas sensing module 12 in the first embodiment, and the part with the same structure will not be described again. Please refer to FIG. 8 and FIG. 9 for further describing the gas sensing module 64 in the second embodiment. In the gas sensing module 64, a hydrophobic polymer layer 1200A is disposed between the working electrode 1200 and the filter module 66 (for example, the working electrode 1200 made of carbon black is configured to face down). A hydrophobic polymer layer 1201A is disposed between the first waterproofing membrane 122-2 and the first auxiliary electrode 1201 (for example, the first auxiliary electrode 1201 made of carbon black is configured to face down). A hydrophobic polymer layer 1202A is disposed between the reference electrode 1202 and the third electrolyte hygroscopic membrane 124 (for example, the reference electrode 1202 made of carbon black is configured to face up). A hydrophobic polymer layer 1203A is disposed between the third electrolyte hygroscopic membrane 124 and the second auxiliary electrode 1203 (for example, the second auxiliary electrode 1203 made of carbon black is configured to face down). The second spacer 123 further includes a fifth electrolyte hygroscopic membrane 123-3 disposed between the second waterproofing membrane 123-2 and the reference electrode 1202. The gas sensing module 64 further includes four electrode lines corresponding to the working electrode 1200, the first auxiliary electrode 1201, the reference electrode 1202, and the second auxiliary electrode 1203, respectively (not shown). A first electrode line (not shown) corresponding to the working electrode 1200 is disposed between the working electrode 1200 and the first electrolyte hygroscopic membrane 122-1, and the first electrode line is electrically connected to the working electrode 1200. A second electrode line (not shown) corresponding to the first auxiliary electrode 1201 is disposed between the first auxiliary electrode 1201 and the second electrolyte hygroscopic membrane 123-1, and the second electrode line is electrically connected to the first auxiliary electrode 1201. A third electrode line (not shown) corresponding to the reference electrode 1202 is disposed between the reference electrode 1202 and the fifth electrolyte hygroscopic membrane 123-3 of the second spacer 123, and the third electrode line is electrically connected to the reference electrode 1202. A fourth electrode line (not shown) corresponding to the reference electrode 1203 is disposed between the second auxiliary electrode 1203 and the fourth electrolyte hygroscopic membrane 125, and the fourth electrode line is electrically connected to the second auxiliary electrode 1203. The first waterproofing membrane 122-2, the hydrophobic polymer layer 1201A, the second waterproofing membrane 123-2 have a first through hole 1221, a second through hole 1201B, and a third through hole 1231, respectively. The first through hole 1221, the second through hole 1201B, and the third through hole 1231 are filled with a first through hole hygroscopic membrane 1222, a second through hole hygroscopic membrane 12011, and a third through hole hygroscopic membrane 1232, respectively. The aforementioned through hole hygroscopic membrane is able to transfer the electrolyte 127 to different layers.

As shown in FIG. 10, in the second embodiment (FIG. 3) according to the present disclosure, the upper part 62 of the inner container includes an upper tank 620, a spacer layer 621, and a lower tank 622. The spacer layer 621 is disposed between the upper tank 620 and the lower tank 622. A plurality of supporting members 626 support the spacer layer 621. The supporting members 626 are able to improve the structural rigidity. The gas sensing module 64 is disposed in the upper tank 620 of the upper part 62 of the inner container. The edge of the upper tank 620 has notches 623. The spacer layer 621 has connection openings 624. The surface of the lower tank 622 includes first fixed members 625. The first to fourth electrode lines respectively pass through the notches 623, extend downward and along the outer edge of the upper part 62 of the inner container and the outer edge of the lower part 63 of the inner container, and are connected to four conductive structures 14-1 to 14-4. The electrolyte 127 can pass through the adsorbate (not shown) in the connection opening 624 of the spacer layer 621 by the capillary effect, and the electrolyte 127 moves to the fourth electrolyte hygroscopic membrane 125 of the gas sensing module 12. As shown in FIG. 1B, the electrolyte 127 in the electrolyte bath 121 is supplied to each of the electrolyte hygroscopic membranes through the passage 16 extending from the lower side to the upper side along the direction T.

As shown in FIG. 11, in the second embodiment (FIG. 3) according to the present disclosure, the lower part 63 of the inner container includes an upper tank 630 of the lower part, second fixed members 631 matched with the first fixed members 625, and a protrusion 632. The second fixed members 631 are located on the surface of the upper tank 630 of the lower part facing the upper part 62 of the inner container. The upper tank 630 of the lower part has a seal hole 633. The electrolyte 127 is injected into the upper tank 630 of the lower part from outside through the seal hole 633, and the seal hole 633 is sealed by a seal member 634. The space surrounded by the upper part 62 of the inner container and the lower part 63 of the inner container forms the electrolyte bath 121. The lower tank 622 of the upper part 62 of the inner container and the upper tank 630 of the lower part 63 of the inner container are matched with each other and integrated together.

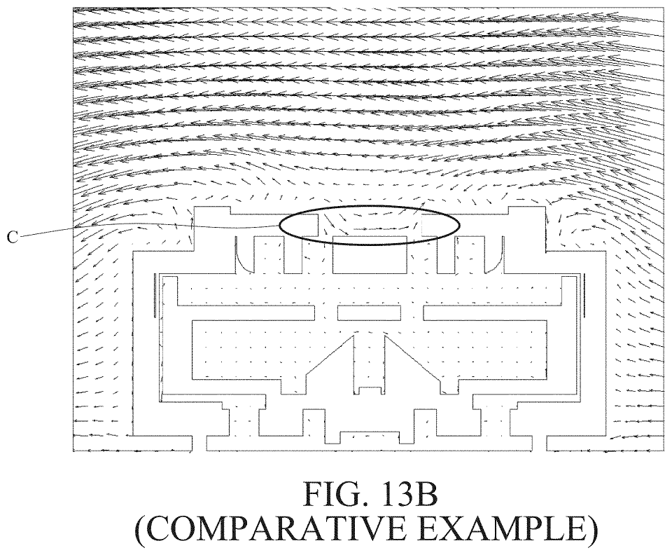

As shown in FIG. 12, in the second embodiment (FIG. 3) according to the present disclosure, the housing 65 has four conductive holes 651 and an opening part 652 for combining with the protrusion 632 of the lower part 63 of the inner container. The four conductive holes 651 correspond to and are plugged in by the four conductive structures 14-1 to 14-4, respectively. Please refer to FIG. 13A and FIG. 13B, FIG. 13A illustrates flow field diagrams of the cover 11 and 61, and the housing 15 and 65 in the first embodiment (FIG. 1A) and the second embodiment (FIG. 3) according to the present disclosure. FIG. 13B illustrates the cover and the housing in the comparative example. The flow rate is 0.4 m/s to 0.6 m/s in the flow field. The airflow is natural wind. The direction of airflow is from the right to the left (shown as arrows). The length of the arrow represents the strength of airflow, the longer arrow means a stronger flow, and the shorter arrow means a weaker flow. As shown in FIG. 13A, when the airflow flows from the right to the left through the cover 11 and 61 of the gas sensing device 10 and 60, a convection A can be generated inside and outside the second opening 1102 without using fans. Moreover, the central part of the fixed structure 130 makes the airflow entering the accommodating space 150 exhibit a swirling distribution B (around the central part of the fixed structure 130), so that the flow can further move to the gas sensing module 12 and 64 in the accommodating space 150 and 650 to improve the convection. In other embodiments, the central part of the fixed structure 130 may not be disposed. Therefore, the partial flow field around the gas sensing device 10 and 60 is enhanced because of the cover 11 and 61 with the sloped surface 113 and the structure in which the diameter D2 of the second opening 1102 is smaller than the diameter D1 of the first opening 1101 so as to improve the airflow diffusibility. In comparison, as shown in FIG. 13B, in a comparative example, when the opening of the cover having a non-slope structure, less air flows into the opening and there is no convection C generated inside and outside the opening (the shorter arrow at the opening). Therefore, the gas enters the gas sensing device mainly by diffusion. As shown in FIG. 13B, a poor mass transfer effect is observed due to a slight airflow disturbance. According to FIG. 13A and FIG. 13B, when the second opening 1102 of the cover 11 and 61 has a smaller diameter than the first opening 1101 (D2<D1) and the cover 11 and 61 includes the sloped surface 113, the partial flow field around the cover 11 and 61 can be adjusted. Thus, as shown in FIG. 13A, better convection is obtained at the second opening 1102, and the airflow entering the accommodating space 150 and 650 exhibits a swirling distribution B due to the central part of the fixed structure 130, thereby increasing the amount of gas entering the gas sensing device 10 and 60 through the first opening 1101 and the second opening 1102. In comparison, in FIG. 13B, the airflow at the opening exhibits a static state C.

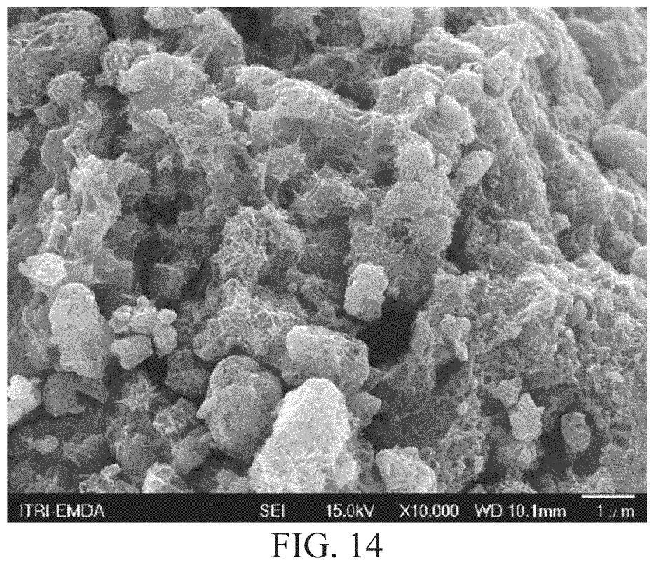

Please refer to FIG. 14, FIG. 14 is a SEM image of the selective filter material 135 including the combination (mixture) of metal oxide and a hydrophobic polymer. As shown in FIG. 14, the selective filter material 135 includes the combination of metal oxide with β or γ crystalline phase one-dimensional nanostructure and a hydrophobic polymer. The mixing ratio of metal oxide to a hydrophobic polymer may be 1:5 to 1:10 (weight ratio).

The following description demonstrates the effect of the ratio (percent by weight) of metal oxides to hydrophobic polymer on filtration efficiency in the selective filter material 135 of the filter module 13 according to the present disclosure. In the first embodiment according to the present disclosure, the ratio of metal oxide (MnO₂) to hydrophobic polymer (PTFE) is listed in Table 1 below.

TABLE 1

| | H1 | | H2 | | H3 | |
|---|---|---|---|---|---|---|
| | (PTFE is 625 μm) | | (PTFE is 350 μm) | | (PTFE is 44 μm) | |
| | | Removal | | Removal | | Removal |
| | MnO₂:PTFE | efficiency | MnO₂:PTFE | efficiency | MnO₂:PTFE | efficiency |
| MnO₂ microsphere | 1:5 | 82% | 1:5 | 82% | 1:5 | 83% |
| particle (comparative | | | | | | |
| example) | | | | | | |
| MnO₂ microsphere | 1:10 | 83% | 1:10 | 82% | 1:10 | 85% |
| particle (comparative | | | | | | |
| example) | | | | | | |
| MnO₂ microsphere | 1:15 | 63% | 1:15 | 60% | 1:15 | 68% |
| particle (comparative | | | | | | |
| example) | | | | | | |
| β-MnO₂ nanowire | 1:5 | 93% | 1:5 | 95% | 1:5 | 96% |
| (embodiment) | | | | | | |
| β-MnO₂ nanowire | 1:10 | 95% | 1:10 | 96% | 1:10 | 100% |
| (embodiment) | | | | | | |
| β-MnO₂ nanowire | 1:15 | 75% | 1:15 | 76% | 1:15 | 84% |
| | | Removal | | Removal | | Removal |
| | γ-MnOOH:PTFE | efficiency | γ-MnOOH:PTFE | efficiency | γ-MnOOH:PTFE | efficiency |
| γ-MnOOH nanowire | 1:5 | 74% | 1:5 | 76% | 1:5 | 78% |
| (embodiment) | | | | | | |
| γ-MnOOH nanowire | 1:10 | 80% | 1:10 | 81% | 1:10 | 83% |
| (embodiment) | | | | | | |
| γ-MnOOH nanowire | 1:15 | 62% | 1:15 | 63% | 1:15 | 65% |

As shown in table 1, the sizes of hydrophobic polymer (PTFE) are 625 μm (H1), 350 μm (H2) and 44 μm (H3), respectively. The mixture ratio of metal oxide (MnO₂) to hydrophobic polymer (PTFE) is 1:5, 1:10 or 1:15. Among the embodiments according to the present disclosure, the selective filter materials 135, in which the ratio of β-MnO₂ nanowires to PTFE is 1:5 or 1:10, are taken as an embodiment group. The selective filter materials including MnO₂ microsphere particles are taken as a comparison group. As shown in Table 1, the removal efficiency (removing ozone) of the embodiment group is higher than 90% (the ratio of β-MnO₂ nanowires to PTFE is 1:5 or 1:10). The removal efficiency (removing ozone) of the selective filter materials 135, in which the ratio of β-MnO₂ nanowires to PTFE is 1:15, is higher than 75%. The removal efficiency of the embodiment group is superior to the comparison group.

In one embodiment, a selective filter material 135, in which the mixture ratio of γ-MnOOH nanowire to hydrophobic polymer PTFE is 1:10, has O₃ removal efficiency higher than 80%. In one embodiment, a selective filter material 135, in which the ratio of γ-MnOOH nanowire to hydrophobic polymer PTFE is 1:5, has O₃ removal efficiency higher than 70%. In a better embodiment, a selective filter material 135, in which the ratio of β-MnO₂ nanowire to hydrophobic polymer PTFE is 1:10, has O₃ removal efficiency which is 100%. Since β-MnO₂ nanowire and γ-MnOOH nanowire have larger absorption areas (absorption surface) and higher absorption efficiency (compared with particles), the removal efficiency of the interfering gas (03) is higher than 99%. Moreover, according to the size of PTFE and corresponding O₃ removal efficiency, it can be understood that a smaller size of hydrophobic polymer is favorable for better O₃ removal efficiency.

Please refer to FIG. 15, FIG. 15 is a schematic view of the gas sensing system 50 according to the third embodiment of the present disclosure. As shown in FIG. 15, the gas sensing system 50 according to the third embodiment of the present disclosure includes a carrier 20, a first gas sensing device 30 and a second gas sensing device 40. The first gas sensing device 30 is disposed on the carrier 20. The second gas sensing device 40 is disposed on the carrier 20. The structures of the first gas sensing device 30 and the second gas sensing device 40 according to the third embodiment of the present disclosure are similar with the gas sensing device 10 (FIG. 1A) according to the first embodiment and the gas sensing device 60 (FIG. 3) according to the second embodiment of the present disclosure. Therefore, the same structures will not be described again and only the differences will be explained below. That is, the first gas sensing device 30 and the second gas sensing device 40 are illustrated by the gas sensing device 10 according to the first embodiment as an example. The first gas sensing device 30 and the second gas sensing device 40 in the third embodiment may be substituted by the gas sensing device 60 in the second embodiment (not shown). The second gas sensing device 40 includes the filter module 13. The following demonstrates the gas sensing device 10 according to the first embodiment as an example, but the present disclosure is not limited thereto.

In the third embodiment, the carrier 20 may be a printed circuit board (PCB) plastic substrate. The first gas sensing device 30 does not include the filter module, and the second gas sensing device 40 includes a filter module 13.

In the third embodiment according to the present disclosure, the gas sensing system further includes a circuit (not shown), a microprocessor (not shown) and a power supply (not shown). The power supply may be a battery. The gas sensing system 50 uses a low noise circuit for data collection, utilizes a microprocessor to calculate the data collected from the first gas sensing device 30 and the second gas sensing device 40, and uses visualized software to show the calculated data, thereby determining the concentration of at least one analyte (such as NO₂ and/or O₃). The gas sensing system 50 may also include thermal-sensing and/or humidity-sensing elements.

The following describes the gas sensing process of the gas sensing system 50 according to the third embodiment of the present disclosure. In the third embodiment according to the present disclosure, the concentration of detected gas containing both the target gas and the interfering gas can be detected through the first gas sensing device 30 without the filter module. On the other hand, since the second gas sensing device 40 includes the filter module 13, the concentration of the target gas can be detected through the second gas sensing device 40. The concentration of the interfering gas removed by the filter module 13 can be obtained through subtracting the concentration of the target gas detected by the second gas sensing device 40 from the concentration of detected gas detected by the first gas sensing device 30. Therefore, the gas sensing system 50 according to the third embodiment of the present disclosure has the ability to precisely detect the concentrations of the interfering gas and the target gas.

For example, the detected gas, detected by the first gas sensing device 30, includes NO₂ and O₃ (R1=[NO₂]+[O₃]). The detected gas detected by the second gas sensing device 40 includes NO₂ (R2=[NO₂]), and O₃ has been absorbed through the filter module 13. In other words, the second gas sensing device 40 can detect the target gas (NO₂). The concentration of the interfering gas (03) can be obtained through subtracting the concentration of NO₂ detected by the second gas sensing device 40 from the total concentration of NO₂ and O₃ detected by the first gas sensing device 30 (R1−R2=[NO₂]+[O₃]−[NO₂]=[O₃]). That is, the signal of the target gas can be obtained by means of electrical signal deduction.

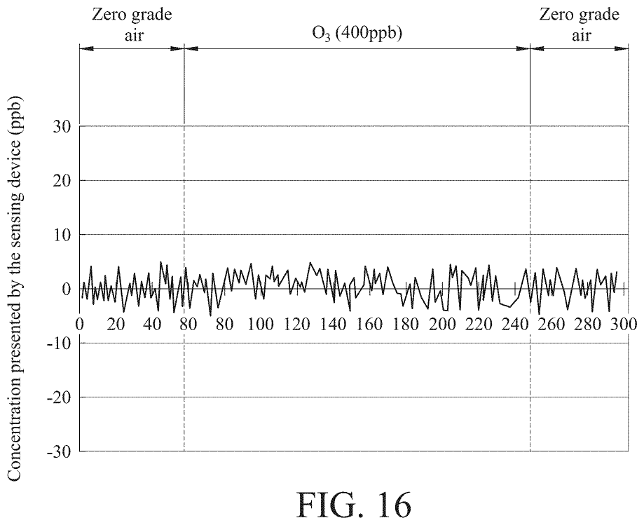

Please refer to FIG. 16, FIG. 16 is a diagram for gas concentration detected by the second gas sensing device 40 including a filter module 13 according to the present disclosure, the horizontal axis represents time (s), the vertical axis represents the concentration presented by the sensing device (ppb). As shown in FIG. 16, in the period of introducing 400 ppb of O₃, there is no particular fluctuation in the detection of the second gas sensing device 40. This is because O₃ is completely absorbed and decomposed by the filter module 13. From the results in FIG. 16, it is known that the detection result of the second gas sensing device 40 is not affected by the introduced O₃. Therefore, FIG. 16 shows that the filter module 13 has an excellent O₃ absorption effect.

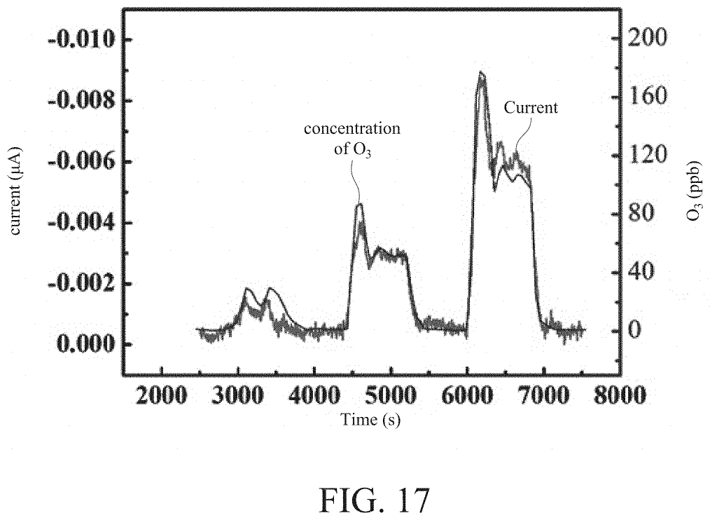

FIG. 17 is a curve diagram for the current depending on the time of the gas sensing system 50 according to the third embodiment of the present disclosure. As to the sensitivity of the gas sensing system 50 according to the present disclosure, various concentrations of O₃ are firstly generated by the zero grade air generator and the dilution air generator. The O₃-containing gas is introduced into the gas sensing system 50 to acquire the corresponding current. Then, the gas is analyzed by the ozone analyzer to determine the concentration of O₃. Please refer to FIG. 17, FIG. 17 is a curve diagram for the current depending on the time of the gas sensing system 50 according to the second embodiment of the present disclosure. As shown in FIG. 17, the left vertical axis represents the current (μA) obtained by the gas sensing system 50. The right vertical axis represents the O₃ concentration (ppb) obtained by the ozone analyzer (Ecotech serinus 10). The horizontal axis represents time (s). The current obtained by the gas sensing system 50 is corresponding to the O₃ concentration obtained by the ozone analyzer, and the obtained current (solid line) is close to the actual O₃ concentration. As such, the sensitivity of the gas sensing system 50 is up to 0-100 ppb. From the result in FIG. 17, it is known that though the structure of the gas sensing system, according to the present disclosure, is not complicated, the ppb level of O₃ can still be obtained, and the gas sensing system has an ability to detect ppb level.

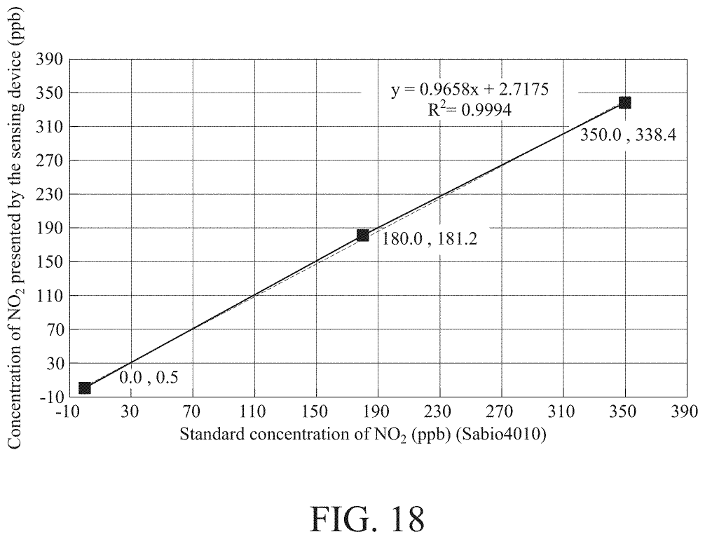

Please refer to FIG. 18, FIG. 18 is a diagram for the concentration of NO₂ detected by the gas sensing system 50 according to the third embodiment of the present disclosure. As shown in FIG. 18, the vertical axis represents the NO₂ concentration obtained by the gas sensing system 50 according to the present disclosure, the horizontal axis represents the NO₂ concentration obtained by a commercial gas detector. As shown in FIG. 18, for example, the point (180.0, 181.2) represents the NO₂ concentration obtained by a commercial gas detector is 180.0 ppb; the NO₂ concentration obtained by the gas sensing system 50 according to the present disclosure is 181.2 ppb. The correlation of linear regression y=0.9658x+2.7175 is obtained by the curved diagram, and the slope is 0.9658 which is very close to 1 (X=Y), it is known that the effect of the gas sensing system 50 according to the present disclosure for NO₂ is similar to the commercial gas detector, and the present disclosure has sufficient reliability to meet the commercial requirements.

According to the gas sensing device and the gas sensing system of the present disclosure, the partial flow field around the cover can be adjusted because of the cover with the structure in which the diameter of the second opening is smaller than the diameter of the first opening and the structure of the sloped surface, so that the amount of gas entering the gas sensing device can increase through the first opening and the second opening. In this way, as the amount of gas entering the gas sensing device increase, the sensitivity and accuracy of the gas sensing device according to the present disclosure for detection of gas concentration can also be improved. Moreover, in the gas sensing device and the gas sensing system, the sensitivity and the accuracy can be improved and the low concentration detection limit can be achieved through the working electrode including ternary metal nanostructure or monatomic metal particles and filter module including metal oxide nanostructure. In addition, the gas sensing device and the gas sensing system can be used for long-term environmental monitoring.

What is claimed is:

1. A gas sensing device, comprising:
a housing having an accommodating space;
a cover disposed on the housing, the cover having a top surface, a bottom surface and a gas passage, the bottom surface facing the accommodating space, the gas passage communicated with the accommodating space, the gas passage having a first opening and a second opening, the first opening located on the top surface, the second opening located on the bottom surface, and an area of the first opening is larger than an area of the second opening; and
a gas sensing module disposed in the accommodating space.

2. The gas sensing device of the claim 1, further comprising a filter module, the filter module comprising a fixed structure and a selective filter material, the fixed structure disposed on the cover and located in the accommodating space, the selective filter material disposed in the fixed structure, the selective filter material covering the second opening, the selective filter material comprising a metal oxide with a one-dimensional nanostructure.

3. The gas sensing device of claim 2, wherein the one-dimensional nanostructure is β or γ crystalline phase.

4. The gas sensing device of claim 3, wherein the metal oxide comprises MnO₂, Mn₂O₃, Mn₃O₄ or MnOOH.

5. The gas sensing device of claim 1, wherein the gas sensing module comprises a working electrode, a first auxiliary electrode, a reference electrode, a second auxiliary electrode, and an electrolyte bath, the first auxiliary electrode is located between the working electrode and the reference electrode, the reference electrode is located between the first auxiliary electrode and the second auxiliary electrode, the second auxiliary electrode is located between the reference electrode and the electrolyte bath.

6. The gas sensing device of claim 5, wherein the working electrode comprises a porous material and a nanowire structure carried on the porous material, the nanowire structure is a ternary metal.

7. The gas sensing device of claim 6, wherein the ternary metal consists of any three metals selected from a group consisting of Pt, Pd, Co, Ag, Sn, Cu, Ni, Au, and Ru.

8. The gas sensing device of claim 7, wherein the ternary metal comprises PtCoAg, PtSnAg, and PtPdNi.

9. The gas sensing device of claim 5, wherein the working electrode comprises a porous material and a plurality of monatomic metal particles carried on the porous material, and the monatomic metal particles are made of Pt, Pd, Co, Ag, Sn, Cu, Ni, Au, or Ru.

10. The gas sensing device of claim 5, wherein the working electrode comprises a porous material, a plurality of first monatomic metal particles and a plurality of second monatomic particles carried on the porous material, the first monatomic metal particles are made of Pt, Pd, Co, Ag, Sn, Cu, Ni, Au, or Ru, the second monatomic metal particles are made of Pt, Pd, Co, Ag, Sn, Cu, Ni, Au, or Ru, and the second monatomic metal particles and the first monatomic metal particles are made of different material.

11. A gas sensing system, comprising:
a carrier;
a first gas sensing device disposed on the carrier and having the structure of the gas sensing device of the claim 1; and
a second gas sensing device disposed on the carrier and having the structure of the gas sensing device of the claim 1, the second gas sensing device further comprising a filter module, the filter module comprising a fixed structure and a selective filter material, the fixed structure disposed on the cover and located in the accommodating space, the selective filter material disposed in the fixed structure, and the selective filter material covering the second opening.

12. The gas sensing system of claim 11, wherein the selective filter material comprises a metal oxide with a one-dimensional nanostructure.

13. The gas sensing system of claim 12, wherein the one-dimensional nanostructure is β or γ crystalline phase.

14. The gas sensing system of claim 12, wherein the metal oxide comprises MnO₂, Mn₂O₃, Mn₃O₄ or MnOOH.
